(19) United States
(12) Patent Application Publication
(10) Pub. No.: US 2024/0401652 A1
(43) Pub. Date: Dec. 5, 2024

(54) BRAKE APPARATUS

(71) Applicant: HL MANDO CORPORATION, Pyeongtaek-si (KR)

(72) Inventor: Hatem SHAHIN, Pfaffenhofen (DE)

(73) Assignee: HL MANDO CORPORATION, Pyeongtaek-si (KR)

(21) Appl. No.: 18/385,083

(22) Filed: Oct. 30, 2023

(30) Foreign Application Priority Data
May 30, 2023 (DE) 102023205027.7

(51) Int. Cl. F16D 51/24; F16D 65/10; F16D 65/807

(52) U.S. Cl. CPC F16D 51/24; F16D 65/10; F16D 65/807; F16D 2065/788

(57) ABSTRACT

A brake apparatus for a vehicle includes a drum configured to rotate together with a wheel of the vehicle, a pair of brake shoes to which linings for rubbing against a friction surface on an inner circumferential side of the drum are attached, and a wheel cylinder disposed to contact one end of each of the pair of brake shoes and configured to operate the pair of brake shoes outwardly by receiving braking hydraulic pressure, and the drum has an air flow path allowing air flow formed inside the friction surface such that the lining and the friction surface are separated by the air flow.

### CROSS-REFERENCE TO RELATED APPLICATION

This application is based on and claims priority under 35 U.S.C. § 119 to German Patent Application No. 102023205027.7, filed on May 30, 2023 in the German Patent and Trade Mark Office, the disclosures of which are incorporated herein by reference.

### BACKGROUND

### 1. Field

Embodiments of the present disclosure relate to a brake apparatus for preventing unnecessary contact of a brake shoe with a drum by maintaining a distance between the brake shoe and the drum in a drum brake.

### 2. Description of the Related Art

In vehicles, a brake system for braking is necessarily installed, and various types of brake systems have been suggested for the safety of drivers and passengers.

In general, brake apparatuses may be classified into caliper-type brakes and drum-type brakes (hereinafter referred to as “drum brakes”).

The drum brake is an apparatus that obtains a braking force by rubbing a brake shoe having a lining attached thereto against an inner circumferential surface of a drum using hydraulic pressure or a parking cable connected to a parking brake operating lever. In general, the drum brake includes a drum provided in a cylindrical shape and rotating together with a wheel, a pair of brake shoes disposed on a back plate to face an inner circumferential surface of the drum and each having a lining attached to an outer circumference thereof, and a wheel cylinder with a built-in piston that receives braking hydraulic pressure and operates each brake shoe outward in a radial direction.

A drum brake in the related art has a problem in that the brake shoes apply non-symmetrical pressure to the drum and, accordingly, a distance between the brake shoes and the drum after brake release is not constant. This may cause an incorrect result due to partial contact between the brake shoes and the drum under certain conditions in a traveling situation of a vehicle.

### SUMMARY

Therefore, it is an aspect of the present disclosure to provide a brake apparatus in which a structure of a drum is changed to create a constant distance between a brake shoe and a drum using an aerodynamic effect during traveling and a control method thereof.

Additional aspects of the disclosure will be set forth in part in the description which follows and, in part, will be obvious from the description, or may be learned by practice of the disclosure.

In accordance with one aspect of the present disclosure, a brake apparatus for a vehicle includes a drum configured to rotate together with a wheel of the vehicle, a pair of brake shoes to which linings for rubbing against a friction surface on an inner circumferential side of the drum are attached, and a wheel cylinder disposed to contact one end of each of the pair of brake shoes and configured to operate the pair of brake shoes outwardly by receiving braking hydraulic pressure, and the drum has an air flow path allowing air flow formed inside the friction surface such that the lining and the friction surface are separated by the air flow.

The air flow path may include a first air flow path extending in an axial direction of the drum and provided inside the friction surface and a second air flow path extending from the first air flow path to the friction surface.

A plurality of first air flow paths may be provided along a side edge of the friction surface, a plurality of second air flow paths may extend from the first air flow path toward the friction surface, and the first air flow paths and the second air flow paths may be arranged at a set number and interval so that the linings and the friction surface maintain a set distance.

In the second air flow path, a first opening connected to the first air flow path and a second opening connected to the friction surface may be connected to each other, and a flow path diameter may be formed to be the same.

In the second air flow path, a first opening connected to the first air flow path and a second opening connected to the friction surface may be connected to each other, and a flow path diameter may be changed in a set pattern.

In the second air flow path, the first opening of a first diameter and the second opening of a second diameter may be connected, and the first diameter and the second diameter may be different from each other so that the flow path diameter is formed in a sequentially varied shape.

In the second air flow path, a first opening connected to the first air flow path and a second opening connected to the friction surface may be connected to each other and a flow path diameter may be formed so that a part thereof is changed in a set pattern and a remaining part thereof is the same.

In the second air flow path, the first opening of a first diameter and the second opening of a second diameter are connected, and the first diameter and the second diameter may be different from each other so that the flow path diameter may be formed to be sequentially varied from the first opening to an inflection point and to be the same from the inflection point to the second opening.

In accordance with another aspect of the present disclosure, a brake apparatus for a vehicle includes a drum configured to rotate together with a wheel of the vehicle, a pair of brake shoes to which linings for rubbing against a friction surface on an inner circumferential side of the drum are attached, a wheel cylinder disposed to contact one end of each of the pair of brake shoes and configured to operate the pair of brake shoes outwardly by receiving braking hydraulic pressure, and a restoring member configured to exert a set elastic force and connected to the pair of brake shoes to provide a restoring force after outward operation of the pair of brake shoes, and the drum has an air flow path allowing air flow formed inside the friction surface in consideration of the restoring force of the restoring member such that the lining and the friction surface are separated by the air flow.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a front view of a brake apparatus in accordance with one embodiment of the present disclosure;

FIG. 2 is a vertical cross-sectional view of the brake apparatus in accordance with one embodiment of the present disclosure;

FIG. 3 is a front view of a drum included in the brake apparatus in accordance with one embodiment of the present disclosure;

FIG. 4 is a view illustrating a partially cut structure of the drum in accordance with one embodiment of the present disclosure;

FIG. 5 is a view illustrating an example of an air flow path of the brake apparatus in accordance with one embodiment of the present disclosure;

FIG. 6 is a view illustrating another example of the air flow path of the brake apparatus in accordance with one embodiment of the present disclosure;

FIG. 7 is a view illustrating still another example of the air flow path of the brake apparatus in accordance with one embodiment of the present disclosure; and

FIG. 8 is a front view of a brake apparatus in accordance with another embodiment of the present disclosure.

### DETAILED DESCRIPTION

Like reference numerals refer to like elements throughout the specification. Not all elements of embodiments will be described in the specification, and general information in the technical field to which the present disclosure pertains or overlapping information between the embodiments will be omitted. The terms “part,” “module,” “member,” or “block” as used throughout the specification may be implemented in software or hardware, and a plurality of “parts,” “modules,” “members,” or “blocks” may be implemented in a single component, or a single “part,” “module,” “member,” or “block” may include a plurality of components.

It will be understood that when a component is referred to as being “connected” to another component throughout the specification, it can be directly or indirectly connected to the other component. When a component is indirectly connected to another component, it may be connected to the other component through a wireless communication network.

In addition, when a part “includes” or “comprises” a component, unless described to the contrary, the term “includes” or “comprises” does not indicate that the part excludes another component but instead indicates that the part may further include the other component.

In the entire specification, when a member is said to be located “on” another member, this includes not only a case where a member is in contact with another member, but also a case where another member exists between the two members.

Terms such as first, second, etc., are used to distinguish one component from another component, and the components are not limited by the above-described terms.

Unless the context clearly indicates otherwise, the singular forms include the plural forms.

In each operation, identification codes are used for convenience of description but are not intended to illustrate the order of the operations, and each operation may be implemented in an order different from the illustrated order unless explicitly stated in the context.

Hereinafter, a working principle and embodiments of the present disclosure will be described with reference to the accompanying drawings.

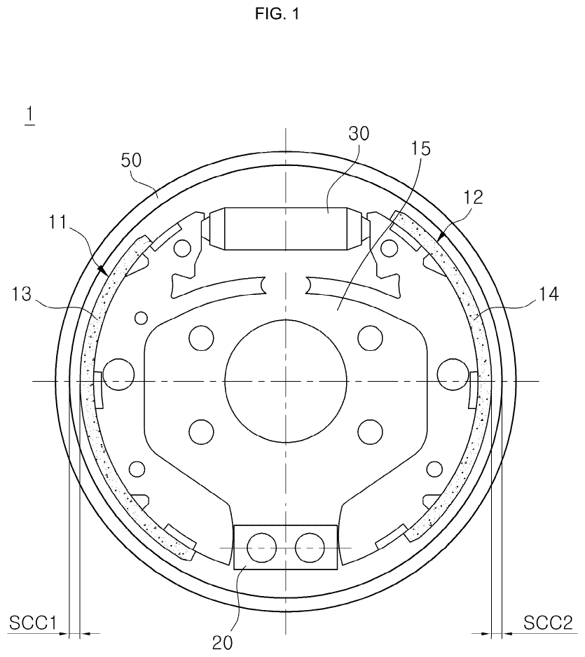

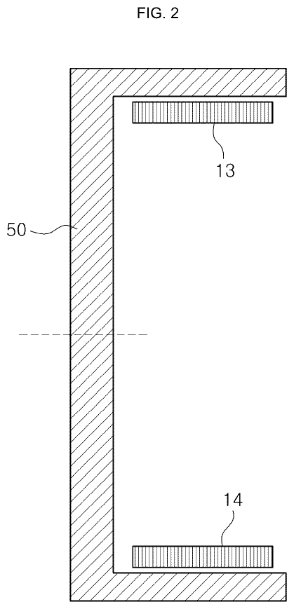

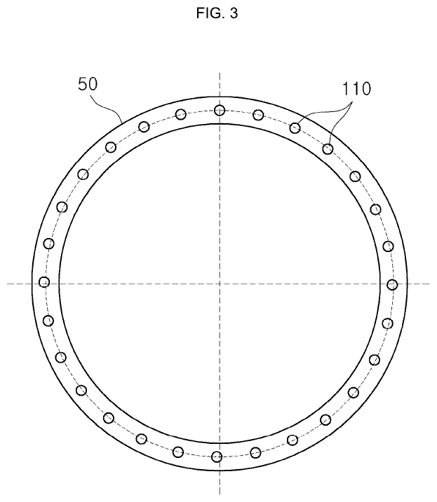

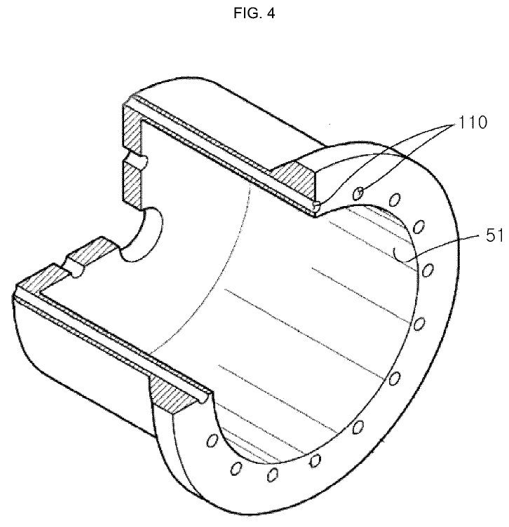

FIG. 1 is a front view of a brake apparatus in accordance with one embodiment of the present disclosure. FIG. 2 is a vertical cross-sectional view of the brake apparatus in accordance with one embodiment of the present disclosure. FIG. 3 is a front view of a drum included in the brake apparatus in accordance with one embodiment of the present disclosure. FIG. 4 is a view illustrating a partially cut structure of the drum in accordance with one embodiment of the present disclosure.

First, referring to FIGS. 1 to 4, a brake apparatus 1 in accordance with one embodiment of the present disclosure may be composed of a drum brake and may include a drum 50, a back plate 15, a pair of brake shoes 11 and 12 and a wheel cylinder 30.

The drum 50 may be a cylindrical member that rotates together with a wheel of a vehicle and may generate a braking force by rubbing a friction surface 51 on an inner circumferential side thereof against linings 13 and 14 attached to the pair of brake shoes 11 and 12, respectively.

The back plate 15 may be a member to which components of the brake apparatus 1, except for the drum 50, are fixed, and disposed to be coupled to a vehicle body. In addition, the back plate 15 may include an anchor block 20 disposed at a lower end to support one end or the other end of each of the pair of brake shoes 11 and 12, one end of which is disposed in contact with the wheel cylinder 30.

The pair of brake shoes 11 and 12 may be mounted on the back plate 15 to be operable outward and generate the braking force by coming into close contact with the friction surface 51 on the inner circumferential side of the drum 50.

More specifically, the pair of brake shoes 11 and 12 may be provided in an arc shape and include a first brake shoe 11 supported by the anchor block 20 disposed at the lower end of the back plate 15 and disposed on a side in a forward rotation direction of the drum 50 around the anchor block 20, and a second brake shoe 12 disposed opposite to the first brake shoe 11. The first and second brake shoes 11 and 12 may include semicircular rims (not illustrated) to which the linings 13 and 14 are attached, respectively, and webs (not illustrated) coupled to inner circumferential surfaces of the rims to support the rims.

The wheel cylinder 30 may include a built-in piston to receive braking hydraulic pressure and operate the first and second brake shoes 11 and 12 outwardly in a radial direction. In addition, the wheel cylinder 30 may be disposed between the first and second brake shoes 11 and 12 to contact one end of each of the first and second brake shoes 11 and 12, and may receive the braking hydraulic pressure and operate the first and second brake shoes 11 and 12 outwardly so that the respective linings 13 and 14 of the first and second brake shoes 11 and 12 come into close contact with the friction surface 51 of the drum 50. For example, when the braking hydraulic pressure is transmitted to the wheel cylinder 30, the piston built into the wheel cylinder 30 advances outward, and accordingly, while the other end of each of the first and second brake shoes 11 and 12 is pushed outward and the one end thereof rotates around the anchor block, the linings 13 and 14 are rubbed against the friction surface 51 of the drum 50, and thus the braking force is generated.

Hereinafter, a structure of the drum 50 included in the brake apparatus 1 in accordance with one embodiment of the present disclosure will be described in more detail.

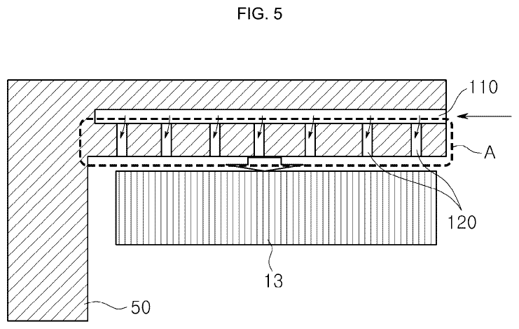

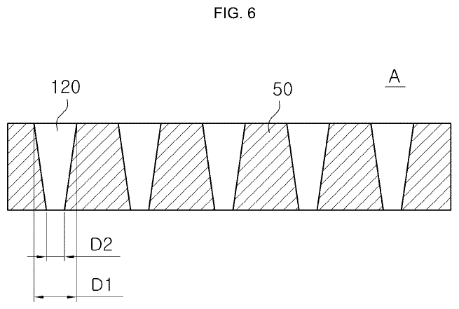

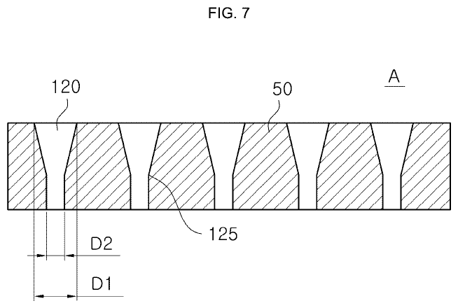

FIG. 5 is a view illustrating an example of an air flow path of the brake apparatus in accordance with one embodiment of the present disclosure. FIG. 6 is a view illustrating another example of the air flow path of the brake apparatus in accordance with one embodiment of the present disclosure. FIG. 7 is a view illustrating still another example of the air flow path of the brake apparatus in accordance with one embodiment of the present disclosure.

In the drum 50, air flow paths 110 and 120 allowing air flow may be formed inside the inner circumferential friction surface 51 so that the respective linings 13 and 14 of the first and second brake shoes 11 and 12 are separated from the friction surface 51 by the air flow.

Here, the air flow paths 110 and 120 may include a first air flow path 110 extending in an axial direction of the drum 50 and provided inside the friction surface 51 and a second air flow path 120 extending from the first air flow path 110 to the friction surface 51.

A plurality of first air flow paths 110 may be provided along a side edge of the friction surface 51. In addition, the first air flow paths 110 may be arranged at a set number and interval so that the respective linings 13 and 14 of the first and second brake shoes 11 and 12 and the friction surface of the drum 50 maintain a set distance. For example, 28 first air flow paths 110 may be arranged at equal intervals on the side edge of the friction surface 51.

A plurality of second air flow paths 120 may extend from the first air flow path 110 toward the friction surface 51 of the drum 50. In addition, the second air flow paths 120 may be arranged at a set number and interval so that the respective linings 13 and 14 of the first and second brake shoes 11 and 12 and the friction surface of the drum 50 maintain a set distance. For example, seven second air flow paths 120 may be arranged at equal intervals in the first air flow paths 110 to correspond to a width of each of the linings 13 and 14 and extend to the friction surface 51.

In one example, in the second air flow path 120, a first opening connected to the first air flow path 110 and a second opening connected to the friction surface 51 may be connected to each other as illustrated in FIG. 5, and a flow path diameter may be formed to be substantially the same. However, in the second air flow path 120, the diameter may be variously set to maintain distances SCC1 and SCC2 between the lining 13 and the friction surface 51 and between the lining 14 and the friction surface 51.

In another example, in the second air flow path 120, a first opening connected to the first air flow path 110 and a second opening connected to the friction surface 51 may be connected to each other as illustrated in FIG. 6, and a flow path diameter may be changed in a set pattern. For example, in the second air flow path 120, the first opening of a first diameter D1 and the second opening of a second diameter D2 may be connected, and the first diameter D1 and the second diameter D2 may be different from each other so that the flow path diameter is formed in a sequentially varied shape. In this case, the first diameter D1 may be greater than the second diameter D2 or vice versa.

In still another example, in the second air flow path 120, a first opening connected to the first air flow path 110 and a second opening connected to the friction surface 51 may be connected to each other as illustrated in FIG. 7, and a flow path diameter may be formed so that a part thereof is changed in a set pattern and a remaining part thereof is substantially the same. For example, in the second air flow path 120, the first opening of a first diameter D1 and the second opening of a second diameter D2 may be connected, and the first diameter D1 and the second diameter D2 may be different from each other so that the diameter is formed in a varied shape. However, in the second air flow path 120, the diameter may be formed to be sequentially varied from the first opening to an inflection point 125 and to be substantially the same from the inflection point 125 to the second opening. In this case, the first diameter D1 may be greater than the second diameter D2 or vice versa.

As described above, the second air flow path 120 may allow air flow pushing the linings 13 and 14 so that the set distance between the linings 13 and 14 and the friction surface 51, for example, about 0.1 mm, is maintained using a pressure difference between the first air flow path 110 and the friction surface 51.

The brake apparatus 1 in accordance with one embodiment of the present disclosure may maintain a constant distance between the linings 13 and 14 and the friction surface 51 at any position using an aerodynamic effect during traveling, and thus may reduce or prevent residual drag torque between the linings 13 and 14 and the friction surface 51.

In addition, the brake apparatus 1 in accordance with one embodiment of the present disclosure may solve problems of fuel efficiency deterioration of the vehicle and premature wear of the linings by reducing or preventing the residual drag torque.

In addition, the brake apparatus 1 in accordance with one embodiment of the present disclosure may maintain constant distances between the linings 13 and 14 and the friction surface 51 without using complicated and heavy parts.

In addition, the brake apparatus 1 in accordance with one embodiment of the present disclosure may support cooling of the drum using air flow, and thus may reduce or prevent noise generation due to the use of mechanical parts.

In addition, the brake apparatus 1 in accordance with one embodiment of the present disclosure may clear and collect brake dust by sucking air through air flow paths.

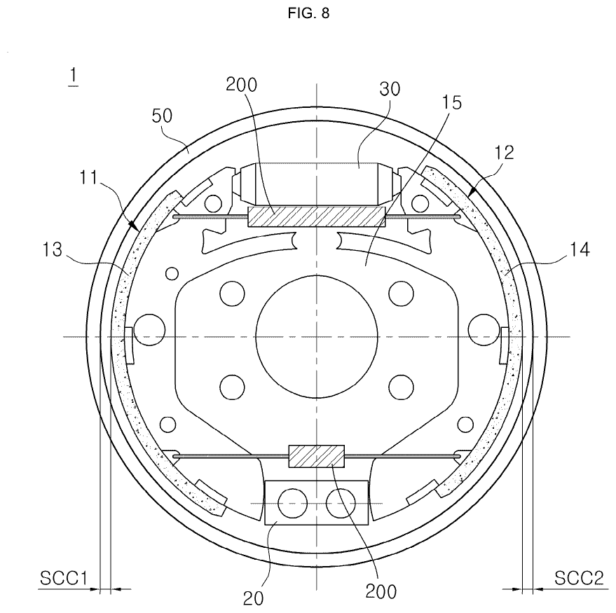

FIG. 8 is a front view of a brake apparatus in accordance with another embodiment of the present disclosure.

Next, referring to FIG. 8, a brake apparatus 1 in accordance with another embodiment of the present disclosure may be composed of a drum brake and may include a drum 50, a back plate 15, a pair of brake shoes 11 and 12, a wheel cylinder 30, and a restoring member 200.

Here, for convenience, overlapping descriptions with the brake apparatus in accordance with one embodiment of the present disclosure are omitted. In addition, air flow paths 110 and 120 will be described with reference to FIGS. 5 to 7.

The restoring member 200 may include a spring made of an elastic string material that exerts a set elastic force and may be connected to the first and second brake shoes 11 and 12 to provide a restoring force after the outward operation of the first and second brake shoes 11 and 12.

In addition, the restoring member 200 may be formed in the form of a fixing part fixed to the back plate 15 and may be formed in a shape of bridges extending from both sides thereof and connected to the first and second brake shoes 11 and 12, respectively.

In the drum 50, the air flow paths 110 and 120 allowing air flow may be formed inside an inner circumferential friction surface 51 in consideration of the restoring force of the restoring member 200 so that the respective linings 13 and 14 of the first and second brake shoes 11 and 12 are separated from the friction surface 51 by the restoring force of the restoring member 200 and the air flow.

Here, the air flow paths 110 and 120 may include a first air flow path 110 extending in an axial direction of the drum 50 and provided inside the friction surface 51 and a second air flow path 120 extending from the first air flow path 110 to the friction surface 51.

A plurality of first air flow paths 110 may be provided along a side edge of the friction surface 51. In addition, the first air flow paths 110 may be arranged at a set number and interval in consideration of the restoring force of the restoring member 200 so that the respective linings 13 and 14 of the first and second brake shoes 11 and 12 and the friction surface of the drum 50 maintain a set distance. For example, 16 first air flow paths 110 may be arranged at equal intervals on the side edge of the friction surface 51.

A plurality of second air flow paths 120 may extend from the first air flow path 110 toward the friction surface 51 of the drum 50. In addition, the second air flow paths 120 may be arranged at a set number and interval in consideration of the restoring force of the restoring member 200 so that the respective linings 13 and 14 of the first and second brake shoes 11 and 12 and the friction surface of the drum 50 maintain a set distance. For example, five second air flow paths 120 may be arranged at equal intervals in the first air flow paths 110 to correspond to a width of each of the linings 13 and 14 and extend to the friction surface 51.

In one example, in the second air flow path 120, a first opening connected to the first air flow path 110 and a second opening connected to the friction surface 51 may be connected to each other as illustrated in FIG. 5, and a flow path diameter may be formed to be substantially the same. However, in the second air flow path 120, the diameter may be variously set to maintain distances between the lining 13 and the friction surface 51 and between the lining 14 and the friction surface 51.

In another example, in the second air flow path 120, a first opening connected to the first air flow path 110 and a second opening connected to the friction surface 51 may be connected to each other as illustrated in FIG. 6, and a flow path diameter may be changed in a set pattern. For example, in the second air flow path 120, the first opening of a first diameter D1 and the second opening of a second diameter D2 may be connected, and the first diameter D1 and the second diameter D2 may be different from each other so that the flow path diameter is formed in a sequentially varied shape. In this case, the first diameter D1 may be greater than the second diameter D2 or vice versa.

In still another example, in the second air flow path 120, a first opening connected to the first air flow path 110 and a second opening connected to the friction surface 51 may be connected to each other as illustrated in FIG. 7, and a flow path diameter may be formed so that a part thereof is changed in a set pattern and a remaining part thereof is substantially the same. For example, in the second air flow path 120, the first opening of a first diameter D1 and the second opening of a second diameter D2 may be connected, and the first diameter D1 and the second diameter D2 may be different from each other so that the flow path diameter is formed in a varied shape. However, in the second air flow path 120, the diameter may be formed to be sequentially varied from the first opening to an inflection point 125 and to be substantially the same from the inflection point 125 to the second opening. In this case, the first diameter D1 may be greater than the second diameter D2 or vice versa.

As described above, the second air flow path 120 may allow air flow pushing the linings 13 and 14 so that the set distance between the linings 13 and 14 and the friction surface 51, for example, about 0.1 mm, is maintained using a pressure difference between the first air flow path 110 and the friction surface 51. In addition, the second air flow path 120 may be formed with a diameter and structure set to maintain the distances between the linings 13 and 14 and the friction surface 51 together with the restoring force of the restoring member 200 to allow the air flow.

The brake apparatus 1 in accordance with another embodiment of the present disclosure may maintain constant distances between the linings 13 and 14 and the friction surface 51 at any position using the restoring force of the restoring member 200 and the air flow of the air flow paths 110 and 120, and thus may reduce or prevent residual drag torque between the linings 13 and 14 and the friction surface 51.

In addition, the brake apparatus 1 in accordance with another embodiment of the present disclosure may reduce manufacturing costs by using the restoring member 200 having a simple and appropriate restoring force instead of the restoring member 200 having an excellent restoring force.

As is apparent from the above description, it is possible to provide a brake apparatus and a control method thereof, capable of identifying a failure state or an uncontrollable state of the brake apparatus. Thus, the brake apparatus can reduce or prevent residual drag torque and solve problems of fuel efficiency deterioration of a vehicle and premature wear of a lining.

As above, the disclosed embodiments have been described with reference to the accompanying drawings. It will be understood by those skilled in the art that various changes in form and details may be made therein without departing from the spirit and scope of the disclosure as defined by the appended claims and their equivalents. The disclosed embodiments are illustrative and should not be construed as limiting.

What is claimed is:

1. A brake apparatus for a vehicle, comprising:
a drum configured to rotate together with a wheel of the vehicle;
a pair of brake shoes to which linings for rubbing against a friction surface on an inner circumferential side of the drum are attached; and
a wheel cylinder disposed to contact one end of each of the pair of brake shoes and configured to operate the pair of brake shoes outwardly by receiving braking hydraulic pressure,
wherein the drum has an air flow path allowing air flow formed inside the friction surface such that the lining and the friction surface are separated by the air flow.

2. The brake apparatus according to claim 1, wherein the air flow path includes:
a first air flow path extending in an axial direction of the drum and provided inside the friction surface; and
a second air flow path extending from the first air flow path to the friction surface.

3. The brake apparatus according to claim 2, wherein a plurality of first air flow paths are provided along a side edge of the friction surface,
a plurality of second air flow paths extend from the first air flow path toward the friction surface, and
the first air flow paths and the second air flow paths are arranged at a set number and interval so that the linings and the friction surface maintain a set distance.

4. The brake apparatus according to claim 2, wherein in the second air flow path, a first opening connected to the first air flow path and a second opening connected to the friction surface are connected to each other and a flow path diameter is formed to be the same.

5. The brake apparatus according to claim 2, wherein in the second air flow path, a first opening connected to the first air flow path and a second opening connected to the friction surface are connected to each other, and a flow path diameter is changed in a set pattern.

6. The brake apparatus according to claim 5, wherein in the second air flow path, the first opening of a first diameter and the second opening of a second diameter are connected, and the first diameter and the second diameter are different from each other so that the flow path diameter is formed in a sequentially varied shape.

7. The brake apparatus according to claim 2, wherein in the second air flow path, a first opening connected to the first air flow path and a second opening connected to the friction surface are connected to each other, and a flow path diameter is formed so that a part thereof is changed in a set pattern and a remaining part thereof is the same.

8. The brake apparatus according to claim 7, wherein in the second air flow path, the first opening of a first diameter and the second opening of a second diameter are connected, and the first diameter and the second diameter are different from each other so that the flow path diameter is formed to be sequentially varied from the first opening to an inflection point and to be the same from the inflection point to the second opening.

9. A brake apparatus for a vehicle, comprising:
a drum configured to rotate together with a wheel of the vehicle;
a pair of brake shoes to which linings for rubbing against a friction surface on an inner circumferential side of the drum are attached;
a wheel cylinder disposed to contact one end of each of the pair of brake shoes and configured to operate the pair of brake shoes outwardly by receiving braking hydraulic pressure; and
a restoring member configured to exert a set elastic force and connected to the pair of brake shoes to provide a restoring force after outward operation of the pair of brake shoes,
wherein the drum has an air flow path allowing air flow formed inside the friction surface in consideration of the restoring force of the restoring member such that the lining and the friction surface are separated by the air flow.

10. The brake apparatus according to claim 9, wherein the air flow path includes:
a first air flow path extending in an axial direction of the drum and provided inside the friction surface; and
a second air flow path extending from the first air flow path to the friction surface.

11. The brake apparatus according to claim 10, wherein a plurality of first air flow paths are provided along a side edge of the friction surface,
a plurality of second air flow paths extend from the first air flow path toward the friction surface, and
the first air flow paths and the second air flow paths are arranged at a set number and interval so that the linings and the friction surface maintain a set distance.

12. The brake apparatus according to claim 10, wherein in the second air flow path, a first opening connected to the first air flow path and a second opening connected to the friction surface are connected to each other, and a flow path diameter is formed to be the same.

13. The brake apparatus according to claim 10, wherein in the second air flow path, a first opening connected to the first air flow path and a second opening connected to the friction surface are connected to each other, and a flow path diameter is changed in a set pattern.

14. The brake apparatus according to claim 13, wherein in the second air flow path, the first opening of a first diameter and the second opening of a second diameter are connected, and the first diameter and the second diameter are different from each other so that the flow path diameter is formed in a sequentially varied shape.

15. The brake apparatus according to claim 10, wherein in the second air flow path, a first opening connected to the first air flow path and a second opening connected to the friction surface are connected to each other, and a flow path diameter is formed so that a part thereof is changed in a set pattern and a remaining part thereof is the same.

16. The brake apparatus according to claim 15, wherein in the second air flow path, the first opening of a first diameter and the second opening of a second diameter are connected, and the first diameter and the second diameter are different from each other so that the flow path diameter is formed to be sequentially varied from the first opening to an inflection point and to be the same from the inflection point to the second opening.
